(19) United States
(12) Patent Application Publication
(10) Pub. No.: US 2025/0358154 A1
(43) Pub. Date: Nov. 20, 2025

(54) EQUALIZATION SIGNAL PROCESSING CIRCUIT, RECEIVER, AND EQUALIZATION SIGNAL PROCESSING METHOD

(71) Applicant: NEC Corporation, Tokyo (JP)

(72) Inventor: Manabu ARIKAWA, Tokyo (JP)

(73) Assignee: NEC Corporation, Tokyo (JP)

(21) Appl. No.: 19/190,957

(22) Filed: Apr. 28, 2025

(30) Foreign Application Priority Data
May 17, 2024 (JP) 2024-080858

(51) Int. Cl. H04L 25/03

(52) U.S. Cl. CPC H04L 25/03006; H04L 2025/03445; H04L 2025/03522

(57) ABSTRACT

An equalization signal processing circuit includes: a signal division unit that divides an input signal of oversampling of a rational number M/L multiple into M signals; a first frequency domain filter that performs an arithmetic operation of a first filter coefficient on M signals in a frequency domain; a second frequency domain filter that performs an arithmetic operation of a second filter coefficient on, for each L group, M signals on which the arithmetic operation of the first filter coefficient is performed; a time domain conversion unit that converts a signal added for each group into a signal in a time domain; a switch circuit that sequentially selects a signal converted into a signal in the time domain for each group; and a coefficient updating unit that updates the first filter coefficient and the second filter coefficient.

### INCORPORATION BY REFERENCE

This application is based upon and claims the benefit of priority from Japanese patent application No. 2024-080858, filed on May 17, 2024, the disclosure of which is incorporated herein in its entirety by reference.

### TECHNICAL FIELD

The present disclosure relates to an equalization signal processing circuit, a receiver, and an equalization signal processing method.

### BACKGROUND ART

Since introduction of so-called digital coherent technique, which combines coherent reception and digital signal processing, in optical fiber communication, flexible receiver side equalization signal processing by digital signal processing has become possible. In the receiver side equalization signal processing, for example, chromatic dispersion accumulated in an optical fiber transmission path is collectively compensated in a receiver side apparatus.

In the optical fiber communication, a high-speed and large-capacity signal is generally handled. For this reason, high throughput is also required for digital signal processing handling the optical fiber communication. Therefore, magnitude of a calculation amount required for the digital signal processing often becomes a problem. A response of an adaptive equalization filter is adaptively controlled according to a state of a transmission path. The adaptive equalization filter is one of important elements of the receiver side equalization signal processing in the optical fiber communication, and efficiency of the calculation amount is also required for the adaptive equalization filter.

In a case where the adaptive equalization filter compensates for an effect with a large time spread, a large filter capable of expressing a response with a large time spread is used for the adaptive equalization filter, and in the adaptive equalization filter, the calculation amount required for compensation increases. As one of methods for efficiently compensating for the effect with the large time spread, adoption of a frequency domain filter has been considered. In a frequency domain, a convolution arithmetic operation of a filter response to an input signal in a time domain can be handled as simple multiplication. In addition, converting a time domain signal into the frequency domain can be efficiently performed by fast Fourier transform (FFT). For this reason, in a case where a time spread of the response is large, a required calculation amount of the frequency domain filter is reduced as compared with that of a time domain filter.

As a related art, Non Patent Literature 1 (S. Haykin, “adaptive filter theory 4th edition”, Prentice Hall, 2002, chap. 7.) discloses an adaptive frequency domain filter in which a response of a frequency domain filter is adaptively controlled. FIG. 8 is a block diagram illustrating an example of the adaptive frequency domain filter described in Non Patent Literature 1. The adaptive frequency domain filter illustrated in FIG. 8 is a linear adaptive filter. Typically, from a relationship of a Nyquist criterion, the linear adaptive filter operates on two samples of signal per symbol, i.e., an input signal of two-times oversampling.

In an adaptive frequency domain filter 600 illustrated in FIG. 8, a block conversion unit 601 converts a time domain input signal of two-times oversampling into a signal of a block having a certain length for conversion into a frequency domain. In other words, the block conversion unit 601 performs serial/block conversion on the time domain input signal. During the conversion into the frequency domain, periodicity of the blocked signal is assumed. However, for a signal handled in optical communication, assumption of the periodicity of a signal is not generally established. For this reason, an overlap-save method is used. In the overlap-save method, a constant, e.g., 50% overlap between blocks is provided during serial/block conversion of the input signal.

An FFT 602 converts a blocked input signal into a frequency domain signal. A frequency domain filter 603 multiplies an input signal by a filter coefficient for each frequency. An inverse FFT (IFFT) 604 converts an output signal of the frequency domain filter 603 from a signal in the frequency domain to a signal in a time domain. A serial conversion unit 605 converts a blocked signal converted into a signal in the time domain by the IFFT 604 into a serial signal. In other words, the serial conversion unit 605 performs block/serial conversion on an output signal of the IFFT 604. In the conversion into a serial signal, the serial conversion unit 605 leaves only a domain of an output signal of the IFFT 604 not being affected by the assumption of the above-described periodicity, and removes other domains. A down-sampling unit 606 performs half-times down-sampling on an output signal of the serial conversion unit 605. A coefficient of the frequency domain filter 603 is adaptively controlled by using an input signal of the frequency domain filter 603 and an output signal of the serial conversion unit 605.

Herein, an input signal vector being blocked by the block conversion unit 601 is denoted by x. In addition, it is assumed that a size of a time domain serial signal of one-time oversampling with respect to an input signal of one block is N. In a case where an overlap rate is 50%, a length of x is 4N. x is a signal of two-times oversampling, and is represented by the following equation 1.

$$x = {( x [ 0 ] , x [ 1 ] , … , x [ 4 N — 1 ] )}^{T} \qquad ( 1 )$$

In the equation 1, T represents transposition. In a case where a signal vector acquired by converting the input signal vector x into the frequency domain is denoted by X, an input signal vector X in the frequency domain is represented by the following equation 2.

$$X = {( X [ 0 ] , X [ 1 ] , … , X [ 4 N - 1 ] )}^{T} \qquad ( 2 )$$

Assuming k, n=0, 1, . . . , 4N−1, the following equations 3 and 4 are established.

$$x [ n ] = \frac{1}{4 N} {\sum }_{k = 0}^{4 N - 1} X [ k ] exp ( i \frac{2 π kn}{4 N} ) \qquad ( 3 )$$

$$X [ k ] = {\sum }_{n = 0}^{4 N - 1} x [ n ] exp ( - i \frac{2 π kn}{4 N} ) \qquad ( 4 )$$

A filter coefficient vector of the frequency domain filter 603 is denoted by H, and an output vector of the frequency domain filter 603 is denoted by Y₊. An arithmetic operation of a filter coefficient in the frequency domain is represented as an Hadamard product of the filter coefficient vector H and the input signal vector X, as indicated in the following equation 5.

$${Y}_{+} = H ∘ X \qquad ( 5 )$$

A signal vector acquired by converting the output signal vector Y₊ of the frequency domain filter 603 into the time domain by the IFFT 604 is denoted by y₊. The output signal vector y₊ in the time domain includes a domain y not being affected by the assumption of the periodicity and a domain y^{˜} that may be affected by the assumption of the periodicity, as indicated in the following equation 6.

$${y}_{+} = ( \begin{matrix}y \\ \tilde{y}\end{matrix} ) \qquad ( 6 )$$

In a case of assuming 50% overlap, a length of each of y and y^{˜} becomes 2N.

The serial conversion unit 605 removes the domain y^{˜} that may be affected by the assumption of the periodicity from the output signal vector y₊ represented by the above-described equation 6, leaves only the domain y, and then performs the block/serial conversion. The down-sampling unit 606 performs half-times down-sampling on y to be outputted from the serial conversion unit 605, and outputs a down-sampled signal y_{↓2}. A length of y_{↓2} is N. Depending on an algorithm to be used for adaptive control of the filter coefficient, an output signal y_{↓2} being subject to down-sampling may be subjected to phase rotation for carrier phase compensation and frequency offset compensation, and updating of the filter coefficient may be performed.

In a case where a least mean square (LMS) algorithm is used for updating the filter coefficient, the coefficient of the frequency domain filter 603 is updated as follows. A desired signal for the output signal y_{↓2} being subject to half-times down-sampling is denoted by d. In a case where a data-aided LMS algorithm is used, d is a known training signal. In a case where a decision-directed LMS algorithm is used, d is a result of symbol determination of the output signal y_{↓2}. Updating of the frequency domain filter coefficient using the LMS algorithm is represented by the following expression 7.

$$H \to H + 2 α {X}^{*} ∘ D ( \begin{matrix}{e}_{↑ 2} \\ 0\end{matrix} ) \qquad ( 7 )$$

In the above-described expression 7, D is a discrete Fourier transform (DFT) matrix, and a is a step size of the updating. A second term on a right side in the above-described expression 7 represents an update amount of the coefficient.

An error calculation unit 611 calculates the error e between the down-sampled output signal y_{↓2} of one-time oversampling and the desired signal d by the following equation 8.

$$e = d - {y}_{↓ 2} \qquad ( 8 )$$

The error calculation unit 611 outputs a signal e_{↑2} acquired by two-times up-sampling the error e.

A zero insertion unit 612 concatenates a zero vector to the above-described error e_{↑2} being subject to two-times up-sampling. In other words, the zero insertion unit 612 generates a vector (e_{↑2}, 0)^{T} included in the second term on the right side in the above-described expression 7. A part of the zero vector in the vector (e_{↑2}, 0)^{T} is a part corresponding to y^{˜} being removed by the block/serial conversion. An FFT 613 multiplies the vector (e_{↑2}, 0)^{T} by the DFT matrix D, and thereby converts an error signal vector into a frequency domain signal. Multiplying the vector (e_{↑2}, 0)^{T} by the DFT matrix D is equivalent to performing an FFT on the error signal vector.

A complex conjugate calculation unit 614 calculates complex conjugate of the input frequency domain signal X being output from the FFT 602. An Hadamard product calculation unit 615 calculates an Hadamard product of the complex conjugate of the input frequency domain signal X and the error signal vector converted into a frequency domain signal by the FFT 613. A result acquired by multiplying a calculation result of the Hadamard product calculation unit 615 by the step size α is equivalent to a coefficient update amount indicated by the second term on the right side in the above-described expression 7.

An IFFT 616 converts the calculation result of the Hadamard product calculation unit 615 being equivalent to the coefficient update amount in the frequency domain into a signal in the time domain. A zero replacement unit 617 replaces, with zero, a coefficient of the domain being equivalent to overlap in the signal converted into the signal in the time domain by IFFT 616. An FFT 618 converts a signal replaced with zero into a frequency domain signal, i.e., a coefficient update amount in the frequency domain. In a case where the time spread of the response of the frequency domain filter 603 exceeds a time length of the overlap, an effect of wraparound at both ends of the block of the input signal assuming the periodicity cannot be removed even if only y is left in the serial conversion unit 605. The IFFT 616, the zero replacement unit 617, and the FFT 618 are necessary in order to avoid the effect of the wraparound at both ends of the block due to the assumption of the periodicity in the frequency domain filter and to acquire an operation equivalent to the time domain filter, and the operation is referred to as a constraint in the time domain. There is a case where the constraint have a small effect on performance even if omitted.

A coefficient updating unit 619 multiplies an output of the FFT 618 by the step size α. The coefficient updating unit 619 outputs the coefficient update amount being multiplied by the step size α to the frequency domain filter 603, and updates the filter coefficient of the frequency domain filter 603. The above-described expression 7 can be transformed into the following expression 9 by using a vector c=(1,0)^{T} for appropriate coefficient zero replacement.

$$H \to H + 2 α D c ◦ ( {D}^{- 1} ( {X}^{*} ∘ D ( \begin{matrix}{e}_{↑ 2} \\ 0\end{matrix} ) ) \qquad ( 9 )$$

By performing such an operation, adaptive control of the frequency domain filter coefficient is performed. Note that, in the above description, an example of a case where an input/output signal is a one-dimensional signal has been described. However, the above-described operation of coefficient updating is easily extended even in a case where a filter is a multi-input multi-output (MIMO) filter.

As another related art, Non Patent Literature 2 (Md. S. Faruk and K. Kikuchi, “Adaptive frequency-domain equalization in digital coherent optical receivers”, Opt. Express 19 (13), 12789 (2011)) discloses an adaptive frequency domain filter of two-times oversampling of an even-odd type. FIG. 9 is a block diagram illustrating a configuration of a typical adaptive frequency domain filter of two-time oversampling of an even-odd type. In an adaptive frequency domain filter 700 illustrated in FIG. 9, a block conversion unit 701 blocks an input signal of two-times oversampling by providing overlap in previous and subsequent blocks. A delay circuit 702 delays a signal to be output from the block conversion unit 701 by one sample.

A down-sampling unit 703 performs half-times down-sampling on a signal to be output from the block conversion unit 701. A down-sampling unit 706 performs half-times down-sampling on a signal delayed by the delay circuit 702. A signal being subject to half-times down-sampling by the down-sampling unit 703 includes an even-numbered sample. On the other hand, a signal being subject to half-times down-sampling by the down-sampling unit 706 includes an odd-numbered sample.

A FFT 704 converts a block including an even-numbered sample output from the down-sampling unit 703 into a signal in the frequency domain. A FFT 707 converts a block including an odd-numbered sample output from the down-sampling unit 706 into a signal in the frequency domain. A frequency domain filter 705 performs an arithmetic operation of a filter coefficient He on a signal in the frequency domain output from the FFT 704. The frequency domain filter 708 performs an arithmetic operation of a filter coefficient Ho on a signal in the frequency domain output from the FFT 707.

An adder 709 adds an output of the frequency domain filter 705 and an output of the frequency domain filter 708. An IFFT 710 performs an inverse Fourier transform on an output signal of the adder 709, and converts a signal in the frequency domain into a signal in the time domain. A serial conversion unit 711 performs overlap-save type block/serial conversion on a signal in the time domain converted by the IFFT 710. A filter coefficient of each of the frequency domain filters 705 and 708 may be implemented in a method similar to that of updating of the filter coefficient in the adaptive frequency domain filter 600 illustrated in FIG. 8.

As described above, an existing adaptive filter operates on an input signal of two-times oversampling. In contrast, there is an attempt to reduce a sampling rate of an input signal of an adaptive filter into less than two times and reduce a calculation amount. For example, Non Patent Literature 3 (C. Li et al., “Advanced DSP for single-carrier 400-Gb/s PDM-16QAM”, OFC 2016, W4A.4.) discloses an example of an adaptive filter that operates in the time domain on an input signal having an oversampling rate being less than two times and not being an integer multiple of a symbol rate.

In addition, Non Patent Literature 4 (M. Paskov et al., “A fully-blind fractionally-oversampled frequency domain adaptive equalizer”, OFC 2016, Th2A.33.) discloses an example of an adaptive filter that operates in the frequency domain on an input signal having an oversampling rate being less than two times and not being an integer multiple of the symbol rate. The adaptive filter described in Non Patent Literature 4 converts an input signal into a signal in the frequency domain, performs appropriate zero insertion on the signal in the frequency domain, and operates in the frequency domain of two-times oversampling. As described above, the frequency domain filter is multiplication of a coefficient for each frequency. For this reason, even in a case of the adaptive filter described in Non Patent Literature 4 and the frequency domain signal being equivalent to the two-times oversampling, calculation may be performed only on a frequency component not being zero, and the calculation amount of the frequency domain filter is made efficiency.

However, in the adaptive filter described in Non Patent Literature 4, for adaptive coefficient update, it is necessary to calculate an update amount for a frequency domain filter coefficient of two-times oversampling. In order to calculate the update amount of the frequency domain filter coefficient, as described above, an FFT of an error appropriately inserted at zero, and an IFFT and an FFT for a constraint of the coefficient update amount in the time domain are required. These calculation amounts depend on a size of the error or the coefficient update amount to be handled, and as the size increases, the calculation amount increases. In addition, the larger the oversampling rate to be handled, the smaller a time width per sample. For this reason, if a time width of a filter is constant, it is necessary to handle a filter coefficient of a large size, and an error or a coefficient update amount in the frequency domain of two-times oversampling, as compared with a case of an oversampling rate less than two times. This leads to an increase in calculation amount.

Non Patent Literature 5 (M. Arikawa and K. Hayashi, “Frequency-domain adaptive MIMO filter with fractional oversampling using stochastic gradient descent for long-haul transmission over coupled 4-core fibers”, Opt. Express 31 (8), 13104 (2023).) discloses a frequency domain filter operating in the frequency domain on a signal of oversampling of a rational number multiple being less than two times of a symbol rate, and adaptive filter coefficient control thereof. In Non Patent Literature 5, a frequency domain filter that operates with oversampling of a M/L multiple (M and L are integers) less than two times and adaptive filter coefficient control thereof are directly achieved.

### SUMMARY

In a frequency domain filter described in Non Patent Literature 5, an input signal is a signal of oversampling of a rational number multiple, and an output signal is a signal of one-time sampling. For this reason, there is a large constraint on sizes of a FFT and an IFFT included in the frequency domain filter. In general, it is known that the FFT and the IFFT can be efficiently calculated in a case where their size is a power of two. However, in the frequency domain filter described in Non Patent Literature 5, the sizes of the FFT and the IFFT cannot always be selected to be a power of two at any M and L values. This complicates circuit design and calculation.

An example object of the present disclosure is to provide an equalization signal processing circuit, a receiver, and an equalization signal processing method that are capable of relaxing complexity of circuit design.

In a first example aspect, an equalization signal processing circuit according to the present disclosure includes: a signal division unit configured to divide, into M signals, an input signal of oversampling of a rational number M/L multiple in which M and L are natural numbers satisfying 1<M/L<2; a frequency domain conversion unit configured to convert each of the divided M signals into a signal in a frequency domain; a first frequency domain filter configured to perform an arithmetic operation of a first filter coefficient on M signals converted into a signal in the frequency domain; a second frequency domain filter configured to perform an arithmetic operation of a second filter coefficient on, for each L group, M signals on which the arithmetic operation of the first filter coefficient is performed; an adder configured to add, for each group, M signals on which the arithmetic operation of second filter coefficient is performed; a time domain conversion unit configured to convert, for each group, an output signal of the adder into a signal in a time domain; a switch circuit configured to sequentially select, for each group, a signal converted into a signal in the time domain; and a coefficient updating unit configured to calculate a gradient of a loss function for the first filter coefficient and a gradient of the loss function for the second filter coefficient by using an error back propagation method, by using, as the loss function, a magnitude of a difference between a signal output from the switch circuit and a predetermined value, and update the first filter coefficient and the second filter coefficient.

In a second example aspect, a receiver according to the present disclosure includes: a detector configured to coherently receive a signal transmitted from a transmitter via a transmission path; and an equalization signal processing circuit configured to perform equalization signal processing on the coherently received signal. The equalization signal processing circuit includes: a signal division unit configured to divide, into M signals, an input signal of oversampling of a rational number M/L multiple in which M and L are natural numbers satisfying 1<M/L<2; a frequency domain conversion unit configured to convert each of the divided M signals into a signal in a frequency domain; a first frequency domain filter configured to perform an arithmetic operation of on a first filter coefficient on M signals converted into a signal in the frequency domain; a second frequency domain filter configured to perform the arithmetic operation of a second filter coefficient on, for each L group, M signals on which the arithmetic operation of the first filter coefficient is performed; an adder configured to add, for each group, M signals on which the arithmetic operation of the second filter coefficient is performed; a time domain conversion unit configured to convert, for each group, an output signal of the adder into a signal in a time domain; a switch circuit configured to sequentially select, for each group, a signal converted into a signal in the time domain; and a coefficient updating unit configured to calculate a gradient of a loss function for the first filter coefficient and a gradient of the loss function for the second filter coefficient by using an error back propagation method, by using, as the loss function, a magnitude of a difference between a signal output from the switch circuit and a predetermined value, and update the first filter coefficient and the second filter coefficient.

In a third example aspect, a communication system according to the present disclosure includes a transmitter configured to transmit a signal via a transmission path, and the receiver.

In a fourth example aspect, an equalization signal processing method according to the present disclosure includes: dividing, into M signals, an input signal of oversampling of a rational number M/L multiple in which M and L are natural numbers satisfying 1<M/L<2; converting each of the divided M signals into a signal in a frequency domain; performing an arithmetic operation of a first filter coefficient on M signals converted into a signal in the frequency domain; performing an arithmetic operation of the second filter coefficient on, for each L group, M signals on which the arithmetic operation of the first filter coefficient is performed; adding, for each group, M signals on which the arithmetic operation of the second filter coefficient is performed; converting, for each group, the added output signal into a signal in a time domain; sequentially selecting, for each group, a signal converted into a signal in the time domain, and concatenating a signal of each group; and calculating a gradient of a loss function for the first filter coefficient and a gradient of the loss function for the second filter coefficient by using an error back propagation method, by using, as the loss function, a magnitude of a difference between the concatenated signal and a predetermined value, and updating the first filter coefficient and the second filter coefficient.

An example advantage according to the present disclosure is that an equalization signal processing circuit, a receiver, and an equalization signal processing method according to the present disclosure can relax complexity of circuit design.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram schematically illustrating a configuration example of a communication system according to the present disclosure;

FIG. 2 is a block diagram illustrating a schematic configuration example of a receiver;

FIG. 3 is a block diagram illustrating a configuration example of a signal transmission system according to the present disclosure;

FIG. 4 is a block diagram illustrating an example of digital signal processing in an equalization unit;

FIG. 5 is a block diagram illustrating a configuration example of polarization separation/carrier phase compensation;

FIG. 6 is a schematic diagram illustrating a process of gradient calculation for coefficient updating by error back propagation in a coefficient updating unit;

FIG. 7 is a diagram illustrating a constellation of an adaptive frequency domain filter output signal;

FIG. 8 is a block diagram illustrating an example of an adaptive frequency domain filter described in Non Patent Literature 1;

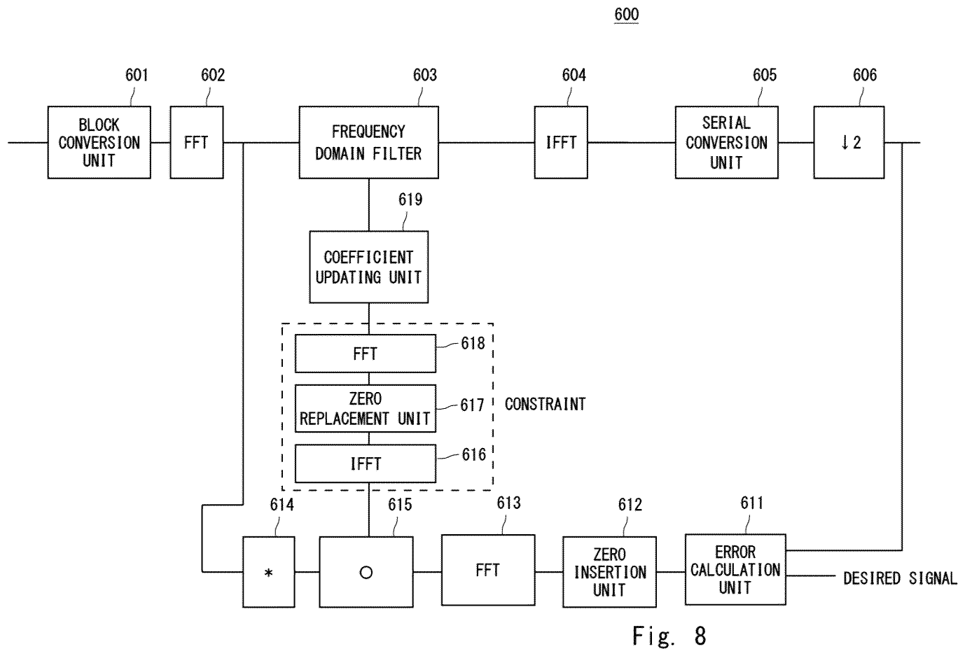

FIG. 9 is a block diagram illustrating a configuration of a typical adaptive frequency domain filter of two-times oversampling of an even-odd type; and

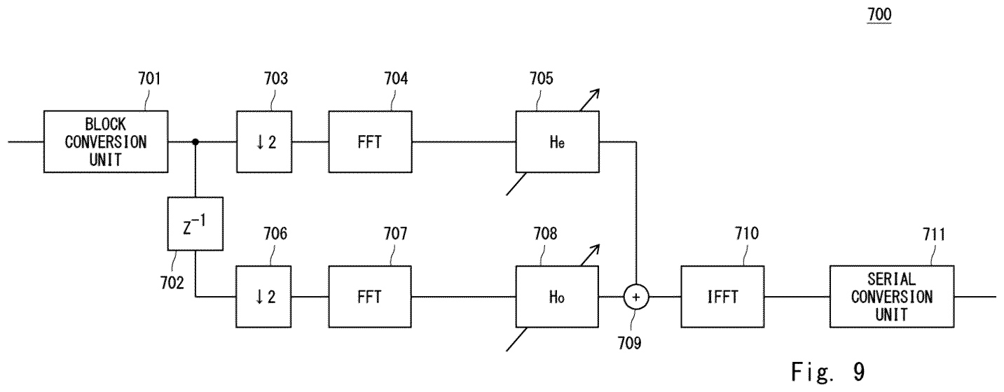

FIG. 10 is a block diagram illustrating a configuration example of a digital signal processing circuit.

### EXAMPLE EMBODIMENT

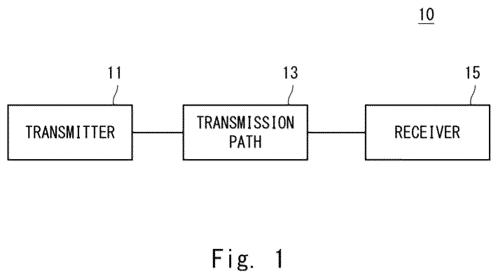

Prior to the description of an example embodiment of the present disclosure, an outline of the present disclosure will be described. FIG. 1 is a block diagram schematically illustrating a configuration example of a communication system according to the present disclosure. A communication system 10 includes a transmitter 11, and a receiver 15. The transmitter 11 and the receiver 15 are connected to each other via a transmission path 13. The transmitter 11 transmits a signal via the transmission path 13. The receiver 15 receives a signal transmitted from the transmitter 11 via the transmission path 13.

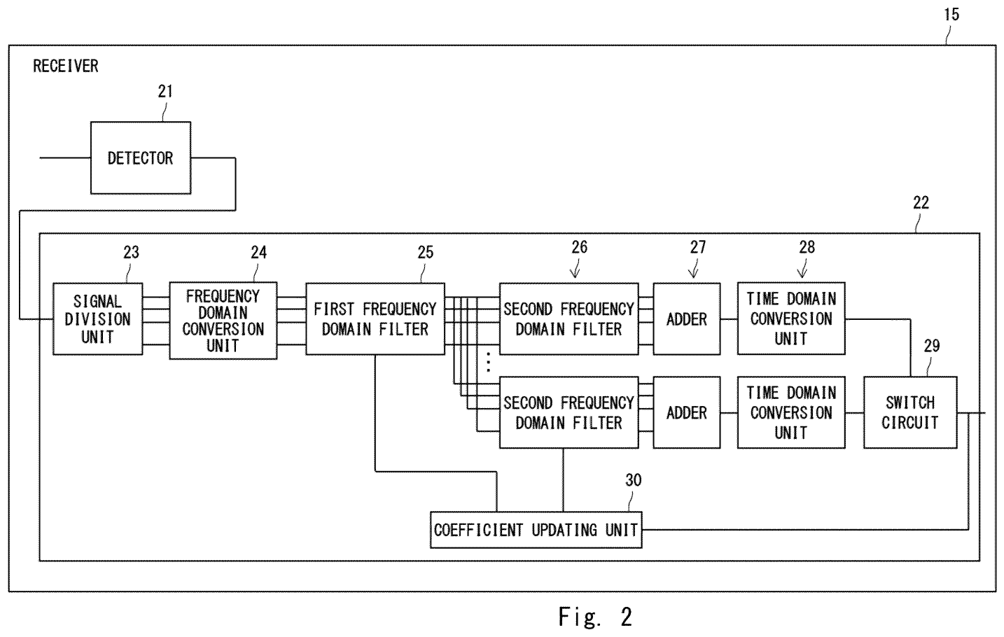

FIG. 2 is a block diagram illustrating a schematic configuration example of the receiver 15. The receiver 15 includes a detector 21, and an equalization signal processing circuit 22. The detector 21 coherently receives a signal transmitted from the transmitter 11. The equalization signal processing circuit 22 performs equalization signal processing on a coherently received input signal of oversampling of a rational number M/L multiple. Herein, M and L are natural numbers satisfying 1<M/L<2.

The equalization signal processing circuit 22 includes a signal division unit 23, a frequency domain conversion unit 24, a first frequency domain filter 25, a second frequency domain filter 26, an adder 27, a time domain conversion unit 28, a switch circuit 29, and a coefficient updating unit 30. The signal division unit 23 divides an input signal of oversampling of a M/L multiple into M signals. The frequency domain conversion unit 24 converts each of the divided M signals into a signal in a frequency domain.

The first frequency domain filter 25 performs an arithmetic operation of a first filter coefficient on M signals converted into a signal in the frequency domain. The second frequency domain filter 26 performs an arithmetic operation of a second filter coefficient on, for each L group, M signals on which the arithmetic operation of the first filter coefficient is performed. The adder 27 adds, for each group, M signals on which the arithmetic operation of the second filter coefficient is performed. The time domain conversion unit 28 converts, for each group, an output signal of the adder 27 into a signal in a time domain.

The switch circuit 29 sequentially selects, for each group, a signal converted into a signal in the time domain. The coefficient updating unit 30 calculates a gradient of a loss function for the first filter coefficient and a gradient of the loss function for the second filter coefficient by using an error back propagation method by using, as the loss function, a magnitude of a difference between a signal output from the switch circuit 29 and a predetermined value. The coefficient updating unit 30 updates each of the first filter coefficient and the second filter coefficient by using the calculated gradient.

In the present disclosure, the frequency domain conversion unit 24 performs conversion on a divided M signals into a signal in the frequency domain. In addition, in each of L groups, the time domain conversion unit 28 performs conversion on a signal output from the adder 27 into a signal in the time domain. In the present disclosure, by appropriately selecting M and L, the frequency domain conversion unit 24 can perform conversion on a signal having a size of a power of two into a signal in the frequency domain. In addition, the time domain conversion unit 28 can perform conversion on a signal having a size of a power of two into a signal in the time domain. For this reason, in the present disclosure, a circuit having a size of a power of two can be used in each of the frequency domain conversion unit 24 and the time domain conversion unit 28, and complexity of circuit design can be relaxed.

Hereinafter, the example embodiment of the present disclosure will be described with reference to the drawings. Note that, the following description and the drawings are omitted and simplified as appropriate for clarity of description. In addition, in each of the following drawings, the same elements and the similar elements are denoted by the same reference signs, and redundant descriptions are omitted as necessary.

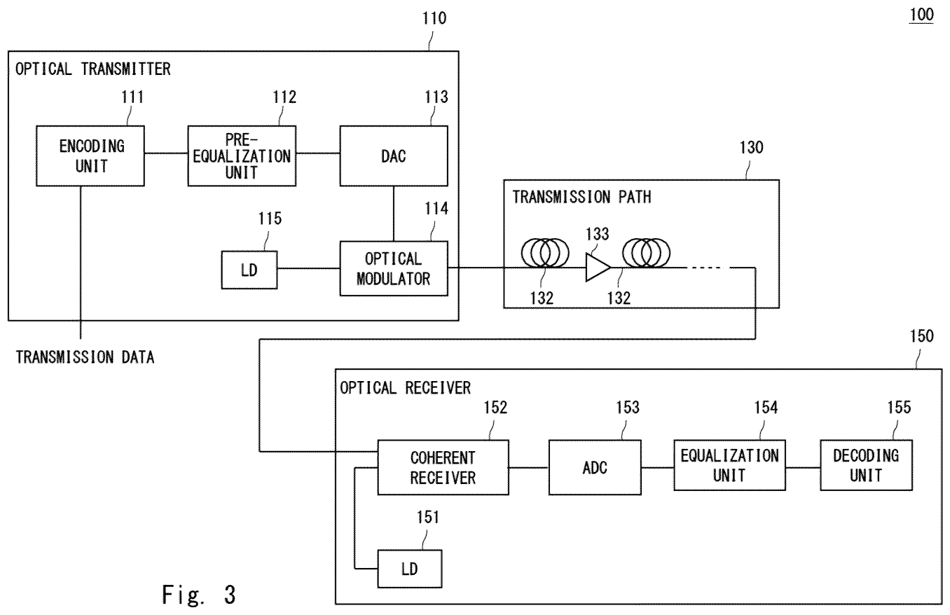

FIG. 3 is a block diagram illustrating a configuration example of a signal transmission system according to the present disclosure. In one example embodiment, it is assumed that the signal transmission system is an optical fiber communication system that adopts a polarization multiplexing QAM system and performs coherent reception. A receiver side adaptive equalization signal processing method according to the present example embodiment is also applicable to spatial multiplexing transmission using a multi-core optical fiber, but an example of single-mode optical fiber transmission will be described below. A wavelength multiplexing technique is often applied to the optical fiber communication system, but a description thereof will be omitted.

An optical fiber communication system 100 includes an optical transmitter 110, a transmission path 130, and an optical receiver 150. The optical fiber communication system 100 constitutes, for example, an optical submarine cable system. The optical fiber communication system 100 corresponds to the communication system 10 illustrated in FIG. 1. The optical transmitter 110 corresponds to the transmitter 11 illustrated in FIG. 1. The transmission path 130 corresponds to the transmission path 13 illustrated in FIG. 1. The optical receiver 150 corresponds to the receiver 15 illustrated in FIG. 1.

The optical transmitter 110 converts transmission data into a polarization multiplexed optical signal. The optical transmitter 110 includes an encoding unit 111, a pre-equalization unit 112, a digital analog converter (DAC) 113, an optical modulator 114, and a laser diode (LD) 115. The encoding unit 111 encodes the transmission data, and generates a signal series for optical modulation. In a case of the polarization multiplexing QAM system, the encoding unit 111 generates a total of four series of signals being an in-phase (I) component and a quadrature (Q) component of each of X polarization (first polarization) and Y polarization (second polarization), respectively. Note that, in FIG. 3, for the sake of simplification of the drawing, encoded four-series signals are illustrated as one solid line. Hereinafter, one solid line illustrated in FIG. 3 may collectively represent signal series having a predetermined number, as a physical entity.

The pre-equalization unit 112 performs pre-equalization for compensating for known distortion or the like of a device in the optical transmitter 110 in advance for the encoded four-series signal. The DAC 113 converts each of the four-series signals being subject to the pre-equalization into an analog electric signal. The LD 115 output continuous wave (CW) light. The optical modulator 114 modulates the CW light output from the LD 115 in response to the four-series signal output from the DAC 113, and generates an optical signal of polarization multiplexing QAM. The optical signal (polarization multiplexed optical signal) generated by the optical modulator 114 is output to the transmission path 130.

The transmission path 130 transmits the polarization multiplexed optical signal output from the optical transmitter 110 to the optical receiver 150. The transmission path 130 includes an optical fiber 132, and an optical amplifier 133. The optical fiber 132 guides an optical signal transmitted from the optical transmitter 110. The optical amplifier 133 amplifies an optical signal, and compensates for a propagation loss in the optical fiber 132. The optical amplifier 133 is configured, for example, as an erbium doped fiber amplifier (EDFA). The transmission path 130 may include a plurality of optical amplifiers 133.

The optical receiver 150 receives an optical signal from the transmission path 130. The optical receiver 150 includes an LD 151, a coherent receiver 152, an analog digital converter (ADC) 153, an equalization unit 154, and a decoding unit 155. In the optical receiver 150, circuits such as the equalization unit (equalizer) 154 and the decoding unit (decoder) 155 may be configured by using a device such as a digital signal processor (DSP), for example.

The LD 151 outputs CW light that becomes local oscillator light to the coherent receiver 152. In the present example embodiment, the coherent receiver 152 is configured as a polarization diversity type coherent receiver. The coherent receiver 152 performs coherent detection on an optical signal transmitted through the optical fiber 132, by using the CW light output from the LD 151. The coherent receiver 152 outputs a four-series reception signal (electric signal) being equivalent to the I component and the Q component of the X polarization and the Y polarization being subject to coherent detection. The coherent receiver 152 corresponds to the detector 21 illustrated in FIG. 2.

The ADC 153 samples the reception signal output from the coherent receiver 152 and converts the reception signal into a signal in a digital domain. The equalization unit 154 performs receiver side equalization signal processing on the four-series reception signal being sampled by the ADC 153. The equalization unit 154 performs equalization signal processing on the reception signal, and thereby compensates for various pieces of distortion occurring in the optical transmitter 110, the transmission path 130, and the optical receiver 150. The decoding unit 155 decodes the signal being subject to the equalization signal processing by the equalization unit 154, and restores the transmitted data. The decoding unit 155 outputs the restored data to not-illustrated another circuit.

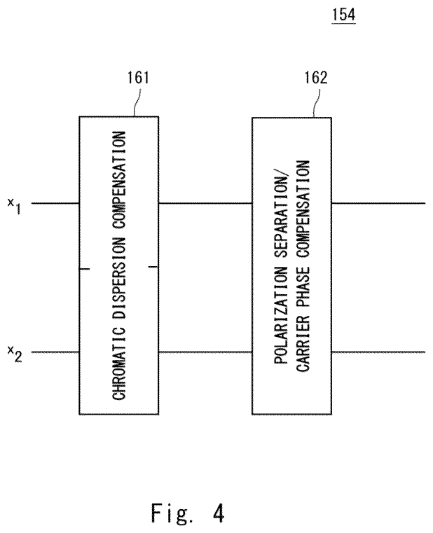

FIG. 4 is a block diagram illustrating an example of digital signal processing in the equalization unit 154. The equalization unit 154 includes a chromatic dispersion compensation 161, and a polarization separation/carrier phase compensation 162. The equalization unit 154 is input a two-series complex signal acquired by converting a sampled four-series reception signal into a complex phasor display for each polarization. The chromatic dispersion compensation 161 performs chromatic dispersion compensation for each polarization. The chromatic dispersion compensation 161 includes a fixed or quasi-static filter whose filter coefficient is determined in such a way as to compensate for chromatic dispersion accumulated in an optical transmission path.

The polarization separation/carrier phase compensation 162 is input a two-series complex signal associated to each of the polarization subjected to chromatic dispersion compensation by the chromatic dispersion compensation 161. The polarization separation/carrier phase compensation 162 performs polarization separation and carrier phase compensation on the input two-series complex signal. A change in a polarization state occurring in the optical transmission path varies with time due to minute pressure and temperature change to an optical fiber. For this reason, a filter for compensating for the change in the polarization state needs to be adaptively controlled. The equalization signal processing circuit according to the present example embodiment is used for the polarization separation/carrier phase compensation 162.

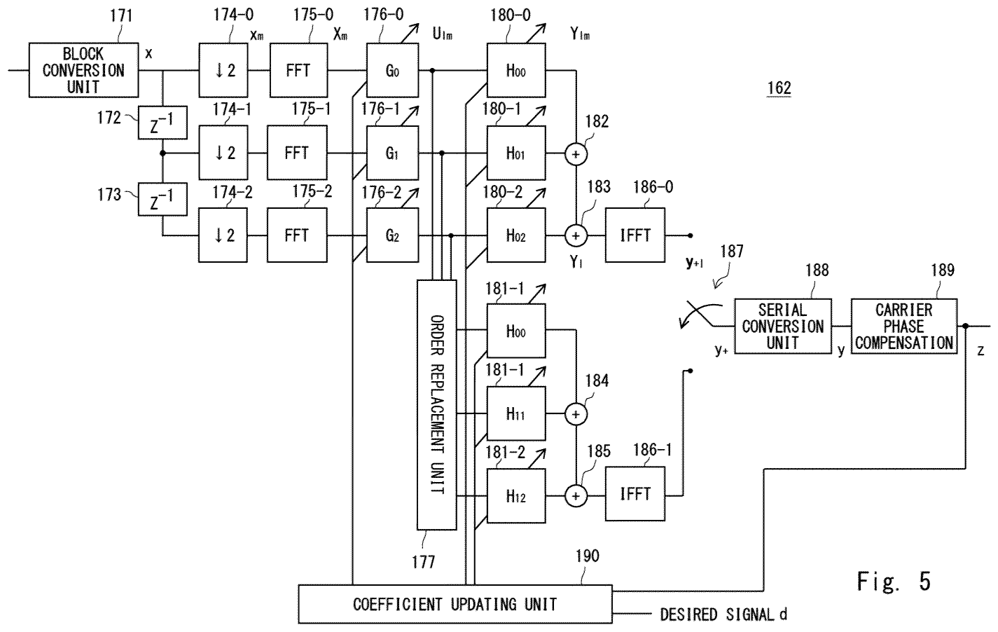

FIG. 5 is a block diagram illustrating a configuration example of the polarization separation/carrier phase compensation 162. The polarization separation/carrier phase compensation 162 corresponds to the equalization signal processing circuit 22 illustrated in FIG. 2. The polarization separation/carrier phase compensation 162 may be configured as a circuit including one or more processors and one or more memories. In this case, at least a part of functions of each unit in the polarization separation/carrier phase compensation 162 may be achieved by the processor reading and executing a program stored in the memory. Each of components of the polarization separation/carrier phase compensation 162 illustrated in FIG. 5 may be configured by using a hardware circuit. Operation of the polarization separation/carrier phase compensation 162 is also referred to as an equalization signal processing method.

Note that, in FIG. 5, compensation in the polarization separation/carrier phase compensation 162 is performed by using a 2×2 adaptive MIMO filter, but for the sake of simplicity, FIG. 5 describes an example of a case where an input/output is a one-series complex signal. In the polarization separation/carrier phase compensation 162, it is assumed that constraint in the time domain at a time of updating a frequency domain filter coefficient is omitted. Operation described below can be easily extended to an adaptive MIMO filter. The configuration illustrated in FIG. 5 is generally an overlap-save type adaptive frequency domain filter.

An input signal is a signal of oversampling of a predetermined multiple. In the present example embodiment, it is assumed that an input signal is a signal of oversampling of a non-integer and rational number multiple. In this case, the input signal is a complex signal series of oversampling of M/L. In other words, the input signal is a complex signal series having a sampling interval LT/M where Tis a symbol interval. Herein, M and L are integers satisfying 1<M/L<2. Hereinafter, a case where M=L+1 will be described. FIG. 5 illustrates a configuration example of the polarization separation/carrier phase compensation 162 in a case where M=3 and L=2.

A block conversion unit 171 performs serial/block conversion on the input complex signal series while providing a constant overlap between blocks. Herein, an overlap rate is assumed to be 50%. An input signal vector blocked by the block conversion unit 171 is denoted by x. The input signal (vector) x is represented by the following equation 10.

$$x = {( x [ 0 ] , x [ 1 ] , … , x [ {N}_{x} - 1 ] )}^{T} \qquad ( 10 )$$

Nₓ represents a size of the blocked input signal x, where Nₓ=2MN/L.

A down-sampling unit 174-0 performs half-times down-sampling on an input signal blocked by the block conversion unit 171. A delay circuit 172 delays a signal output from the block conversion unit 171 by one sample. A down-sampling unit 174-1 performs half-times down-sampling on a signal delayed by the delay circuit 172. A delay circuit 173 further delays a signal output from the delay circuit 172 by one sample. A down-sampling unit 174-2 performs half-times down-sampling on a signal delayed by the delay circuit 173.

The input signal x blocked by the block conversion unit 171 is divided into M signals (vectors) by sample delay and down-sampling of a 1/M multiple. In a case where the divided signal is denoted by xₘ (m=0, 1, . . . , M−1), xₘ is represented by the following equation 11.

$${x}_{m} = {( x [ m ] , x [ M + m ] , … , x [ {N}_{x} - M + m ] )}^{T} \qquad ( 11 )$$

An output signal of the down-sampling unit 174-0 corresponds to x₀. An output signal of the down-sampling unit 174-1 corresponds to x₁. An output signal of the down-sampling unit 174-2 corresponds to x₂. A size of the divided signal xₘ is 2N/L. Each of the delay circuits 172 and 173, and the down-sampling units 174-0 to 174-2 correspond to the signal division unit 23 illustrated in FIG. 2.

The polarization separation/carrier phase compensation 162 includes M pieces of FFTs 175, and M pieces of first frequency domain filters 176. Each of FFTs 175-0 to 175-2 converts the divided signal xₘ into a signal xₘ in the frequency domain. In more detail, the FFT 175-0 converts a signal x₀ output from the down-sampling unit 174-0 into a signal x₀ in the frequency domain. The FFT 175-1 converts a signal x₁ output from the down-sampling unit 174-1 into a signal x₁ in the frequency domain. The FFT 175-2 converts a signal x₂ output from the down-sampling unit 174-2 into a signal x₂ in the frequency domain. The FFT 175 corresponds to the frequency domain conversion unit 24 illustrated in FIG. 2.

Each of first frequency domain filters 176-0 to 176-2 performs the arithmetic operation of a filter coefficient Gₘ on the output signal xₘ of the FFTs 175-0 to 175-2. In more detail, the first frequency domain filter 176-0 performs the arithmetic operation of a filter coefficient G₀ on the signal x₀ output from the FFT 175-0. The first frequency domain filter 176-1 performs the arithmetic operation of a filter coefficient G₁ on the signal x₁ output from the FFT 175-1. The first frequency domain filter 176-2 performs the arithmetic operation of a filter coefficient G₂ on the signal x₂ output from the FFT 175-2. An output signal Yₘ of the first frequency domain filters 176-0 to 176-2 is represented by the following equation 12.

$${Y}_{m} [ k ] = {G}_{m} [ k ] {X}_{m} [ k ] \qquad ( 12 )$$

The first frequency domain filter 176 corresponds to the first frequency domain filter 25 illustrated in FIG. 2.

The polarization separation/carrier phase compensation 162 includes, for each L group, M pieces of second frequency domain filters 180 and 181. In FIG. 5, each of second frequency domain filters 180-0 to 180-2 is a frequency domain filter associated to a group 0. Each of second frequency domain filters 181-0 to 181-2 is a frequency domain filter associated to a group 1.

The second frequency domain filter 180-0 performs the arithmetic operation of a filter coefficient H₀₀ on a signal Y₀ output from the first frequency domain filter 176-0. The second frequency domain filter 180-1 performs the arithmetic operation of a filter coefficient H₀₁ on a signal Y₁ output from the first frequency domain filter 176-1. The second frequency domain filter 180-2 performs the arithmetic operation of a filter coefficient H₀₂ on a signal Y₂ output from the first frequency domain filter 176-2.

An order replacement unit 177 cyclically shifts order of the signals Yₘ output from the first frequency domain filters 176-0 to 176-2 by 1 (1=0, 1, . . . , L−1) associated to the group 1. In the example in FIG. 5, the order replacement unit 177 outputs the signal Y₂ output from the first frequency domain filter 176-2 to the second frequency domain filter 180-0. The order replacement unit 177 outputs the signal Y₀ output from the first frequency domain filter 176-0 to the second frequency domain filter 180-1. The order replacement unit 177 outputs the signal Y₁ output from the first frequency domain filter 176-1 to the second frequency domain filter 180-2.

The second frequency domain filter 181-0 performs the arithmetic operation of a filter coefficient H₁₀ on the signal Y₂ output from the first frequency domain filter 176-2. The second frequency domain filter 181-1 performs the arithmetic operation of a filter coefficient H₁₁ on the signal Y₀ output from the first frequency domain filter 176-0. The second frequency domain filter 181-2 performs the arithmetic operation of a filter coefficient H₁₂ on the signal Y₁ output from the first frequency domain filter 176-1.

Herein, for the sake of convenience, a signal acquired by cyclically shifting the order of the Yₘ by 1 is denoted by U₁ₘ. U₁ₘ is represented by the following equation 13.

$${U}_{l m} = {Y}_{mo d ( m + l , M )} \qquad ( 13 )$$

Each of the second frequency domain filters 180-0 to 180-2 and 181-0 to 181-2 performs the arithmetic operation of H₁ₘ on U₁ₘ. An output signal Yim of each of the second frequency domain filters 180-0 to 180-2 and 181-0 to 181-2 are represented by the following equation 14

$${Y}_{l m} [ k ] = {H}_{l m} [ k ] {U}_{l m} [ k ] \qquad ( 14 )$$

The output signals of the second frequency domain filters 180-0 to 180-2 correspond to Y₀₀ to Y₀₂, respectively. The output signals of the second frequency domain filters 181-0 to 181-2 correspond to Y₁₀ to Y₁₂, respectively. Each of the second frequency domain filters 180 and 181 corresponds to the second frequency domain filter 26 illustrated in FIG. 2.

Adders 182 to 185 add, for each 1, i.e., for each group, the output signal Yim of the second frequency domain filter. In other words, the adders 182 and 183 add the output signals of the second frequency domain filters 180-0 to 180-2 associated to the group 0. The adders 184 and 185 add the output signals of the second frequency domain filters 181-0 to 181-2 associated to the group 1. In a case where output signals of the adders 182 and 183 and output signals of the adders 184 and 185 are denoted by Y₁, Y₁ is represented by the following equation 15.

$${Y}_{l} = {\sum }_{m = 0}^{M - 1} {Y}_{l m} \qquad ( 15 )$$

Each of the adders 182 to 185 corresponds to the adder 27 illustrated in FIG. 2.

The polarization separation/carrier phase compensation 162 includes an IFFT 186 for each group. IFFT 186-0 converts a signal Y₀ output from the adder 183 into a signal in the time domain. IFFT 186-1 converts a signal Y₁ output from the adder 185 into a signal in the time domain. A signal converted into a signal in the time domain by the IFFTs 186-0 and 186-1 is denoted by y₊₁. a size of y₊₁ is 2N/L. The IFFT 186 corresponds to the time domain conversion unit 28 illustrated in FIG. 2.

A switch circuit 187 switches a connection destination of a serial conversion unit 188 between the IFFT 186-0 and the IFFT 186-1. For example, the switch circuit 187 switches the connection destination of the serial conversion unit 188 between the IFFT 186-0 and the IFFT 186-1 for each sample. In other words, the switch circuit 187 switches 1 for each sample, and extracts and arranges the output signal y₊₁ of the IFFT 186-0 and the IFFT 186-1 for each sample. In a case where a signal output from the switch circuit 187 to the serial conversion unit 188 is denoted by y₊, y₊ is represented by the following equation 16.

$${y}_{+} [ n ] = {y}_{+ ( mo d ( n , L ) )} [ ⌊ n / L ⌋ ] \qquad ( 16 )$$

In the equation 16, following is a floor function.
└*┘

A size of y₊ is 2N. The switch circuit 187 corresponds to the switch circuit 29 illustrated in FIG. 2.

The serial conversion unit 188 converts a signal input from the switch circuit 187 into a serial signal in the time domain. In conversion into a serial signal, the serial conversion unit 188 leaves only a domain in a time domain block signal of one-time oversampling not being affected by an assumption of periodicity at a time of conversion into the frequency domain, and removes the others. From a concept of an overlap-save method, y₊ can be represented by the following equation 17.

$${y}_{+} = ( \begin{matrix}y \\ \tilde{y}\end{matrix} ) \qquad ( 17 )$$

The serial conversion unit 188 removes y^{˜} from y₊, and leaves only y. A size of y is N. The serial conversion unit 188 performs block/serial conversion on y. y is a time domain signal of one-time sampling.

A carrier phase compensation filter 189 is a time domain filter, and performs phase rotation for removing a carrier phase and a frequency offset on a serial signal of one-time oversampling in the time domain converted by the serial conversion unit 188. The carrier phase compensation filter 189 applies, to the time domain signal y, a phase rotation separately determined by, for example, a phase-lock loop (PLL) method. An output signal of the carrier phase compensation filter 189 is denoted by z. In a case where a phase rotation amount is denoted by θ, z is represented by the following equation 18.

$$z = y ∘ exp ( i θ ) \qquad ( 18 )$$

A time domain serial signal of one-time oversampling output from the carrier phase compensation filter 189 becomes an output to one block. The above-described operation is performed for each block provided overlap, output signals are connected to each other, and thereby a final output of an overlap-save type adaptive frequency domain filter illustrated in FIG. 5 is acquired.

The first frequency domain filters 176-0 to 176-2 mainly play a role of distortion compensation. In contrast, the second frequency domain filters 180-0 to 180-2 and 181-0 to 181-2 mainly play a role of a decimation filter associated with sampling rate conversion from oversampling of a M/L multiple to one-time sampling. It is assumed that an initial value of the filter coefficient H₁ₘ of the second frequency domain filters 180-0 to 180-2 and 181-0 to 181-2 is selected as follows from noble equivalence and polyphase representation of a filter in multi-rate signal processing.

First, a decimation filter H having an appropriate transmission band having a size of 2 MN is prepared, and the decimation filter His polyphase decomposed into L pieces. This is equivalent to an operation that a filter coefficient in the time domain is shifted by 1 (1=0, 1, . . . , L−1), and extracted every L pieces. For this reason, in the frequency domain, a polyphase-decomposed frequency domain filter H₁ is represented as follows.

$${H}_{l}^{′} [ k ] = H [ k ] exp ( 2 π {if}_{M} [ k ] ( l - 1 ) / M ) \qquad ( 19 )$$

$${H}_{l} [ k ] = \frac{1}{L} {\sum }_{l = 0}^{L - 1} {H}_{l}^{′} [ k - {lN}_{x} ] \qquad ( 20 )$$

Herein, f_{M}[k] is a frequency normalized by a symbol rate associated to an index k at M-times oversampling. This is further polyphase decomposed into M pieces, and thereby H₁ₘ is acquired. In other words, the following is established.

$${H}_{l m}^{′} [ k ] = {H}_{l} [ k ] exp ( 2 π {if}_{x} [ k ] ( m - 1 ) L / M ) \qquad ( 21 )$$

$${H}_{l m} [ k ] = \frac{1}{M} {\sum }_{m = 0}^{M - 1} {H}_{l m}^{′} [ k - m ( 2 N / L ) ] \qquad ( 22 )$$

Herein, fₓ[k] is a frequency normalized by the symbol rate associated to the index k at oversampling of a M/L multiple.

Further, based on the noble equivalence of sampling rate conversion from oversampling of the M/L multiple to one-time sampling in polyphase representation, one sample time delay in a domain of oversampling of a 1/L multiple is given to m′=0, . . . , 1-1 of H₁ₘ. This is established by the following,

$${H}_{l m}^{′} [ k ] \to {H}_{l m}^{′} [ k ] exp ( 2 π {if}_{1 / L} [ k ] L ) \qquad ( 23 )$$

f_{1/L}[k] is a frequency normalized by the symbol rate associated to the index k at oversampling of the 1/L multiple.

In a case of extending to a MIMO filter, the filter coefficient Gₘ of the first frequency domain filters 176-0 to 176-2 are extended to the MIMO filter. In other words, a number of dimensions of an input and output is denoted by K, K is assumed i, j=1, . . . , K, then the following is established.

$${Y}_{m i} [ k ] = {\sum }_{j = 1}^{K} {G}_{mij} [ k ] {X}_{mj} [ k ] \qquad ( 24 )$$

By performing processing of the frequency domain filter H₁ₘ for each Yₘᵢ, MIMO filter processing is performed as a whole.

A coefficient updating unit 190 adaptively updates the filter coefficient Gₘ of the first frequency domain filters 176-0 to 176-2, and the filter coefficient H₁ₘ of the second frequency domain filters 180-0 to 180-2 and 181-0 to 181-2. The coefficient updating unit 190 updates the filter coefficients Gₘ and H₁ₘ, based on the error back propagation and a stochastic gradient descent method, in such a way as to minimize a magnitude of a loss function determined in response to the signal z in the time domain being a final output. The coefficient updating unit 190 corresponds to the coefficient updating unit 30 illustrated in FIG. 2.

Coefficient updating is described. A magnitude of a difference between the signal z being a filter output and a desired signal is referred to as a loss function φ to be minimized. According to a Wirtinger derivative perspective, φ is regarded as a function of a certain filter coefficient ξ and ξ* with respect to ξ. * represents complex conjugate. The filter coefficient ξ is updated as follows by the stochastic gradient descent method.

$$ξ \to ξ - 2 α \frac{\partial ϕ}{\partial {ξ}^{*}} \qquad ( 25 )$$

Herein, α is a step size. Since the loss function to be minimized is a real number, the following equation 26 is established.

$$\frac{\partial ϕ}{\partial {ξ}^{*}} = {( \frac{\partial ϕ}{\partial ξ} )}^{*} \qquad ( 26 )$$

In a case where LMS algorithm is used in constitution of the loss function, the loss function (an instantaneous value for each block thereof) may be defined by the following equation 27 by using a magnitude of a difference between the time domain signal z of one-time oversampling and a desired signal d.

$$ϕ = {{\sum }^{N - 1}}_{n = 0} {\vert d [ n ] - z [ n ] \vert}^{2} \qquad ( 27 )$$

In a case where data-aided LMS algorithm is used, d is a known training signal. In a case where decision-directed LMS algorithm is used, d is a result of symbol determination of z. The loss function is not limited to that described above, and several methods of constituting the loss function to be minimized from a time domain signal of one-time oversampling, such as constant modulus algorithm (CMA) or radius directed equalization (RDE), are known.

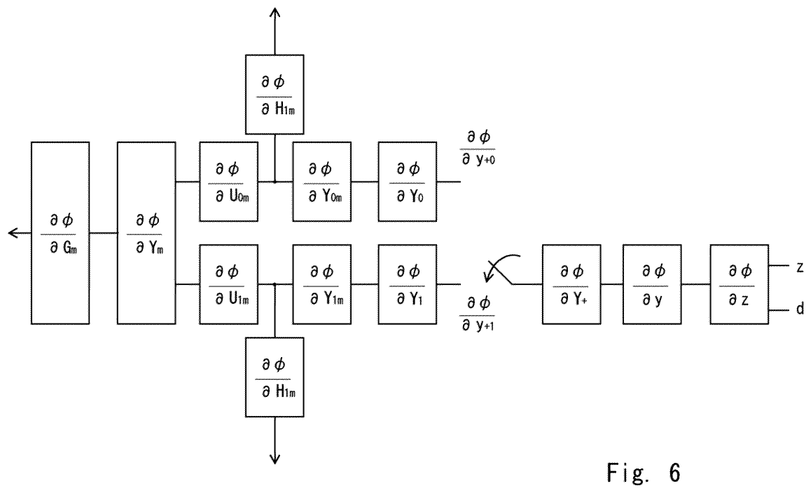

FIG. 6 is a schematic diagram illustrating a process of gradient calculation for coefficient updating by error back propagation in the coefficient updating section 190. In the following description, an example of using the data-aided LMS algorithm is described. The coefficient updating unit 190 retroactively calculates a gradient of the loss function for each signal and filter coefficient, as illustrated in FIG. 6, according to the error back propagation method, i.e., a relationship of a chain rule of a derivative.

A gradient of the loss function φ of the LMS algorithm for the time domain signal z of one-time oversampling of an output is represented by the following equation 28.

$$\frac{\partial ϕ}{\partial z} = - {e}^{*} \qquad ( 28 )$$

Herein, e=d−z. A gradient of the loss function for y is calculated from the gradient for z as in the following equation 29.

$$\frac{\partial ϕ}{\partial y} = \frac{\partial ϕ}{\partial z} ◦ exp ( i θ ) \qquad ( 29 )$$

A gradient of the loss function for y₊ is as follows.

$$\frac{\partial ϕ}{\partial {y}_{+}} = ( \begin{matrix}\frac{\partial ϕ}{\partial y} \\ 0\end{matrix} ) \qquad ( 30 )$$

A gradient of the loss function for y₊₁ is acquired, based on a relationship between y₊₁ and y₊, by distributing a component of the gradient of the loss function for y₊ every L samples by the switch circuit 187. A gradient of the loss function for Y₁ is given as follows.

$$\frac{\partial ϕ}{\partial {Y}_{l}} = {D}^{- 1} \frac{\partial ϕ}{\partial {y}_{+ l}} \qquad ( 31 )$$

A gradient of the loss function for Y₁ₘ is given as follows.

$$\frac{\partial ϕ}{\partial {Y}_{lm}} = \frac{\partial ϕ}{\partial {Y}_{l}} \qquad ( 32 )$$

A gradient of the loss function for H₁ₘ is given as follows.

$$\frac{\partial ϕ}{\partial {H}_{l m}} = \frac{\partial ϕ}{\partial {Y}_{lm}} ◦ {U}_{lm} \qquad ( 33 )$$

In case of the MIMO filter, the gradient of the loss function for H₁ₘ is given as follows.

$$\frac{\partial ϕ}{\partial {H}_{lm}} = {{\sum }^{K}}_{i = 1} \frac{\partial ϕ}{\partial {Y}_{lmi}} ◦ {U}_{lmi} \qquad ( 34 )$$

The coefficient updating unit 190 updates the coefficient H₁ₘ of the second frequency domain filter as in the following expression 35.

$${H}_{lm} \to {H}_{lm} - 2 α \frac{\partial ϕ}{\partial {H}_{lm}^{*}} \qquad ( 35 )$$

A gradient of the loss function for U₁ₘ is given as follows.

$$\frac{\partial ϕ}{\partial {U}_{lm}} = \frac{\partial ϕ}{\partial {Y}_{lm}} ◦ {H}_{lm} \qquad ( 36 )$$

A gradient of the loss function for Yₘ is given as follows by reflecting that U₁ₘ is a cyclic shift in order of Yₘ,

$$\frac{\partial ϕ}{\partial {Y}_{m}} = {\sum }_{l = 0}^{L - 1} \frac{\partial ϕ}{\partial {U}_{l ( mod ( m + 1 , M ) )}} \qquad ( 37 )$$

A gradient of the loss function for Gₘ is given as follows.

$$\frac{\partial ϕ}{\partial {G}_{m}} = \frac{\partial ϕ}{\partial {Y}_{m}} ◦ {X}_{m} \qquad ( 38 )$$

In the case of the MIMO filter, a gradient of the loss function for Gₘᵢⱼ is given as follows.

$$\frac{\partial ϕ}{\partial {G}_{mij}} = \frac{\partial ϕ}{\partial {Y}_{mi}} ◦ {X}_{mj} \qquad ( 39 )$$

The coefficient updating unit 190 updates the coefficient Gₘ of the first frequency domain filter as in the following expression 40.

$${G}_{m} \to {G}_{m} - 2 α \frac{\partial ϕ}{\partial {G}_{m}^{*}} \qquad ( 40 )$$

In this way, a frequency domain filter operating in the frequency domain of oversampling of a rational number multiple being less than two times of a symbol rate, and adaptive filter coefficient control thereof are acquired. A different value for a step size of updating the coefficient Gₘ of the first frequency domain filter and the coefficient H₁ₘ of the second frequency domain filter can be chosen. The coefficient updating unit 190 does not necessarily need to update the coefficient for each of all blocks, and may update the coefficient once every several blocks. In addition, the coefficient updating unit 190 may update the coefficient Gₘ of the first frequency domain filter and the coefficient H₁ₘ of the second frequency domain filter at different update frequency from each other.

As described above, in the frequency domain filter operating in the frequency domain of oversampling of a rational multiple less than two times of the symbol rate, and in the adaptive filter coefficient control thereof, an FFT having a size of 2N/L and an IFFT having the same size of 2N/L are used. If N is a power of two and L is a smaller power of two, the size of the FFT and IFFT becomes a power of two. For this reason, in the present example embodiment, an FFT/IFFT having a size of not a power of two is not required. Therefore, the present example embodiment can relax complication of circuit design related to the FFT/IFFT.

The present inventor has verified operation of the receiver side adaptive equalization signal processing system according to the present example embodiment by simulation. In the simulation, single mode fiber (SMF) 6000 km transmission is simulated for a 32Gbaud polarization multiplexed quadrature phase shift keying (QPSK) signal. In the simulation, the QPSK signal is given chromatic dispersion being equivalent to SMF 6000 km and a polarization rotation of 30°. In addition, an optical signal-to-noise ratio (OSNR) is set at 30 dB/0.1 nm. At a receiver, the QPSK signal is coherently received, and sampled with two-times oversampling. A signal sampled with two-times oversampling is subjected to chromatic dispersion compensation for each polarization, and the signal compensated for chromatic dispersion is resampled to oversampling of a M/L multiple. Herein, L=2 and M=3 are used.

In the simulation, a two-series signal of X polarization and Y polarization resampled to oversampling of the M/L multiple is input to an adaptive frequency domain filter operating in the frequency domain of oversampling of the M/L multiple. In the adaptive coefficient control, the loss function of the data-aided LMS algorithm is used first, and after the filter coefficient is almost converged, the filter coefficient is adaptively controlled by switching to the loss function of the decision-directed LMS algorithm. The overlap rate is set to 50%, and a size of the output after the overlap removal is set to 64. A PLL scheme is used for carrier phase compensation.

Note that, in the simulation, in order to focus on the adaptive frequency domain filter operating in the frequency domain of oversampling of the M/L multiple, resampling to oversampling of the M/L multiple is performed. Instead of performing two-times oversampling on the coherently received signal, the coherently received signal may be sampled by oversampling of the M/L multiple. In this case, the chromatic dispersion compensation is also performed with oversampling smaller than two times. For this reason, the calculation amount in the chromatic dispersion compensation is also relaxed.

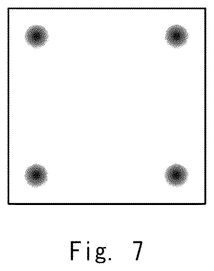

FIG. 7 is a constellation of adaptive frequency domain filter output signals acquired by the above simulation. After the loss function used for adaptive coefficient control is switched to the loss function of the decision-directed LMS algorithm and then the filter coefficient is sufficiently converged, the constellation of the adaptive frequency domain filter output signals is evaluated. FIG. 7 illustrates the constellation of a signal of X polarization.

As illustrated in FIG. 7, from a simulation result, it can be seen that a good constellation of the QPSK signal is acquired. Therefore, it can be confirmed that the frequency domain filter operating in the frequency domain of oversampling of the rational number multiple less than two times and the adaptive coefficient control thereof according to the present example embodiment normally function.

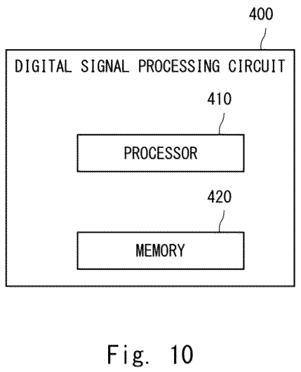

In the above-described example embodiment, the equalization unit 154 may be configured by using any digital signal processing circuit. FIG. 10 illustrates a configuration example of a digital signal processing circuit that may be used as the equalization unit 154. A digital signal processing circuit 400 is configured as a circuit including one or more processors 410, and one or more memories 420. In the digital signal processing circuit 400, one or more processors 410 read programs stored in one or more memories 420, execute processing according to the read programs, and thereby perform receiver side equalization signal processing.

The above program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a Compact Disc (CD), a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as the following supplementary notes, but are not limited thereto.

### [Supplementary Note 1]

An equalization signal processing circuit including:
a signal division unit configured to divide, into M signals, an input signal of oversampling of a rational number M/L multiple in which M and L are natural numbers satisfying 1<M/L<2;
a frequency domain conversion unit configured to convert each of the divided M signals into a signal in a frequency domain;
a first frequency domain filter configured to perform an arithmetic operation of a first filter coefficient on M signals converted into a signal in the frequency domain;
a second frequency domain filter configured to perform an arithmetic operation of a second filter coefficient on, for each L group, M signals on which the arithmetic operation of the first filter coefficient is performed;
   an adder configured to add, for each group, M signals on which the arithmetic operation of the second filter coefficient is performed;
   a time domain conversion unit configured to convert, for each group, an output signal of the adder into a signal in a time domain;
   a switch circuit configured to sequentially select, for each group, a signal converted into a signal in the time domain; and
   a coefficient updating unit configured to calculate a gradient of a loss function for the first filter coefficient and a gradient of the loss function for the second filter coefficient by using an error back propagation method, by using, as the loss function, a magnitude of a difference between a signal output from the switch circuit and a predetermined value, and update the first filter coefficient and the second filter coefficient.

### [Supplementary Note 2]

The equalization signal processing circuit according to supplementary note 1, wherein the equalization signal processing circuit is configured as a circuit that is input a plurality of signals and outputs a plurality of signals, and the first frequency domain filter is configured as a multi-input multi-output (MIMO) filter.

### [Supplementary Note 3]

The equalization signal processing circuit according to supplementary note 1 or 2, wherein the coefficient updating unit updates the first filter coefficient, based on a gradient of the loss function for the first filter coefficient, by a stochastic gradient descent method, and updates the second filter coefficient, based on a gradient of the loss function for the second filter coefficient, by a stochastic gradient descent method.

### [Supplementary Note 4]

The equalization signal processing circuit according to any one of supplementary notes 1 to 3, wherein the input signal is a signal acquired by coherently receiving a signal transmitted through a transmission path by a receiver.

### [Supplementary Note 5]

The equalization signal processing circuit according to any one of supplementary notes 1 to 4, further including a time domain filter configured to perform filter processing in a time domain on a signal output from the switch circuit,
wherein the coefficient updating unit calculates a magnitude of a difference between an output signal of the time domain filter and the predetermined value as a loss function.

### [Supplementary Note 6]

The equalization signal processing circuit according to any one of supplementary notes 1 to 5, wherein the switch circuit switches a group to be selected for each sample.

### [Supplementary Note 7]

The equalization signal processing circuit according to any one of supplementary notes 1 to 6, further including:
a block conversion unit configured to convert the input signal from a serial signal to a block signal while providing a constant overlap between blocks, and input the converted block signal to the signal division unit; and
a serial conversion unit configured to convert a signal output from the switch circuit from a block signal to a serial signal, while a domain not being affected by an assumption of periodicity included in a signal output from the switch circuit is left, and a domain that may be affected by an assumption of periodicity included in a signal output from the switch circuit is removed.

### [Supplementary Note 8]

A receiver including:
a detector configured to coherently receive a signal transmitted from a transmitter via a transmission path; and
an equalization signal processing circuit configured to perform equalization signal processing on the coherently received signal,
wherein the equalization signal processing circuit includes
a signal division unit configured to divide, into M signals, an input signal of oversampling of a rational number M/L multiple in which M and L are natural numbers satisfying 1<M/L<2,
a frequency domain conversion unit configured to convert each of the divided M signals into a signal in a frequency domain,
a first frequency domain filter configured to perform an arithmetic operation of a first filter coefficient on M signals converted into a signal in the frequency domain,
a second frequency domain filter configured to perform an arithmetic operation of a second filter coefficient on, for each L group, M signals on which the arithmetic operation of the first filter coefficient is performed,
an adder configured to add, for each group, M signals on which the arithmetic operation of the second filter coefficient is performed,
a time domain conversion unit configured to convert, for each group, an output signal of the adder into a signal in a time domain,
a switch circuit configured to sequentially select, for each group, a signal converted into a signal in the time domain, and
a coefficient updating unit configured to calculate a gradient of a loss function for the first filter coefficient and a gradient of the loss function for the second filter coefficient by using an error back propagation method, by using, as the loss function, a magnitude of a difference between a signal output from the switch circuit and a predetermined value, and update the first filter coefficient and the second filter coefficient.

### [Supplementary Note 9]

The receiver according to supplementary note 8, wherein the equalization signal processing circuit is configured as a circuit that is input a plurality of signals and outputs a plurality of signals, and the first frequency domain filter is configured as a multi-input multi-output (MIMO) filter.

### [Supplementary Note 10]

The receiver according to supplementary note 8 or 9, wherein the coefficient updating unit updates the first filter coefficient, based on a gradient of the loss function for the first filter coefficient, by a stochastic gradient descent method, and updates the second filter coefficient, based on a gradient of the loss function for the second filter coefficient, by a stochastic gradient descent method.

### [Supplementary Note 11]

The receiver according to any one of supplementary notes 8 to 10, further including a time domain filter configured to perform filter processing in a time domain on a signal output from the switch circuit,
wherein the coefficient updating unit calculates a magnitude of a difference between an output signal of the time domain filter and the predetermined value as a loss function.

### [Supplementary Note 12]

The receiver according to any one of supplementary notes 8 to 11, wherein the switch circuit switches a group to be selected for each sample.

### [Supplementary Note 13]

The receiver according to any one of supplementary notes 8 to 12, further including:
a block conversion unit configured to convert the input signal from a serial signal to a block signal while providing a constant overlap between blocks, and input the converted block signal to the signal division unit; and
a serial conversion unit configured to convert a signal output from the switch circuit from a block signal to a serial signal, while a domain not being affected by an assumption of periodicity included in a signal output from the switch circuit is left, and a domain that may be affected by an assumption of periodicity included in a signal output from the switch circuit is removed.

### [Supplementary Note 14]

A communication system including:
a transmitter configured to transmit a signal via a transmission path; and
the receiver according to any one of supplementary notes 7 to 13.

### [Supplementary Note 15]

An equalization signal processing method including:
dividing, into M signals, an input signal of oversampling of a rational number M/L multiple in which M and L are natural numbers satisfying 1<M/L<2;
converting each of the divided M signals into a signal in a frequency domain;
performing an arithmetic operation of a first filter coefficient on M signals converted into a signal in the frequency domain;
performing an arithmetic operation of a second filter coefficient on, for each L group, M signals on which the arithmetic operation of the first filter coefficient is performed;
adding, for each group, M signals on which the arithmetic operation of the second filter coefficient is performed;
converting, for each group, the added output signal into a signal in a time domain;
sequentially selecting, for each group, a signal converted into a signal in the time domain, and concatenating a signal of each group; and
calculating a gradient of a loss function for the first filter coefficient and a gradient of the loss function for the second filter coefficient by using an error back propagation method, by using, as the loss function, a magnitude of a difference between the concatenated signal and a predetermined value, and updating the first filter coefficient and the second filter coefficient.

Some or all of elements specified in Supplementary Notes 2 to 7 dependent on Supplementary Note 1 may also be dependent on Supplementary Note 15 in dependency similar to that of Supplementary Notes 2 to 7 on Supplementary Note 1. Some or all of elements specified in any of Supplementary Notes may be applied to various types of hardware, software, and recording means for recording software, systems, and methods.

What is claimed is:

1. An equalization signal processing circuit comprising:
at least one memory storing instructions, and
at least one processor configured to execute the instructions to:
divide, into M signals, an input signal of oversampling of a rational number M/L multiple in which M and L are natural numbers satisfying 1<M/L<2,
convert each of the divided M signals into a signal in a frequency domain,
in a first frequency domain filter, perform an arithmetic operation of a first filter coefficient on M signals converted into a signal in the frequency domain,
in a second frequency domain filter, perform an arithmetic operation of a second filter coefficient on, for each L group, M signals on which the arithmetic operation of the first filter coefficient is performed,
add, for each group, M signals on which the arithmetic operation of the second filter coefficient is performed,
convert, for each group, the added output signal into a signal in a time domain,
sequentially select, for each group, a signal converted into a signal in the time domain, and
calculate a gradient of a loss function for the first filter coefficient and a gradient of the loss function for the second filter coefficient by using an error back propagation method, by using, as the loss function, a magnitude of a difference between the sequentially selected signal and a predetermined value, and update the first filter coefficient and the second filter coefficient.

2. The equalization signal processing circuit according to claim 1, wherein the equalization signal processing circuit is configured as a circuit that is input a plurality of signals and outputs a plurality of signals, and the first frequency domain filter is configured as a multi-input multi-output (MIMO) filter.

3. The equalization signal processing circuit according to claim 1, wherein the at least one processor is configured to execute the instructions to:
update the first filter coefficient, based on a gradient of the loss function for the first filter coefficient, by a stochastic gradient descent method, and
update the second filter coefficient, based on a gradient of the loss function for the second filter coefficient, by a stochastic gradient descent method.

4. The equalization signal processing circuit according to claim 1, wherein the input signal is a signal acquired by coherently receiving a signal transmitted through a transmission path by a receiver.

5. The equalization signal processing circuit according to claim 1, wherein the at least one processor is configured to execute the instructions to:
in a time domain filter, perform filter processing in a time domain on the sequentially selected signal, and
calculate a magnitude of a difference between an output signal of the time domain filter and the predetermined value as a loss function.

6. The equalization signal processing circuit according to claim 1, wherein the at least one processor is configured to execute the instructions to:
sequentially select a signal converted into a signal in the time domain for each group while switching a group to be selected for each sample.

7. The equalization signal processing circuit according to claim 1, wherein the at least one processor is configured to execute the instructions to:
convert the input signal from a serial signal to a block signal while providing a constant overlap between blocks,
divide the converted block signal into M signals, and
convert the sequentially selected signal from a block signal into a serial signal, while a domain not being affected by an assumption of periodicity included in the sequentially selected signal is left, and a domain that may be affected by an assumption of periodicity included in the sequentially selected signal is removed.

8. A receiver comprising:
a detector configured to coherently receive a signal transmitted from a transmitter via a transmission path; and
an equalization signal processing circuit configured to perform equalization signal processing on the coherently received signal,
wherein the equalization signal processing circuit comprising:
at least one memory storing instructions, and
at least one processor configured to execute the instructions to:
dividing, into M signals, an input signal of oversampling of a rational number M/L multiple in which M and L are natural numbers satisfying 1<M/L<2,
convert each of the divided M signals into a signal in a frequency domain,
in a first frequency domain filter, perform an arithmetic operation of a first filter coefficient on M signals converted into a signal in the frequency domain,
in a second frequency domain filter, perform an arithmetic operation of a second filter coefficient on, for each L group, M signals on which the arithmetic operation of the first filter coefficient is performed,
add, for each group, M signals on which the arithmetic operation of the second filter coefficient is performed,
convert, for each group, the added output signal into a signal in a time domain,
sequentially select, for each group, a signal converted into a signal in the time domain, and
calculate a gradient of a loss function for the first filter coefficient and a gradient of the loss function for the second filter coefficient by using an error back propagation method, by using, as the loss function, a magnitude of a difference between the sequentially selected signal and a predetermined value, and update the first filter coefficient and the second filter coefficient.

9. The receiver according to claim 8, wherein the equalization signal processing circuit is configured as a circuit that is input a plurality of signals and outputs a plurality of signals, and the first frequency domain filter is configured as a multi-input multi-output (MIMO) filter.

10. The receiver according to claim 8, wherein the at least one processor is configured to execute the instructions to:
update the first filter coefficient, based on a gradient of the loss function for the first filter coefficient, by a stochastic gradient descent method, and
update the second filter coefficient, based on a gradient of the loss function for the second filter coefficient, by a stochastic gradient descent method.

11. The receiver according to claim 8, wherein the at least one processor is configured to execute the instructions to:
in a time domain filter, perform filter processing in a time domain on the sequentially selected signal, and
calculate a magnitude of a difference between an output signal of the time domain filter and the predetermined value as a loss function.

12. The receiver according to claim 8, wherein the at least one processor is configured to execute the instructions to:
sequentially select a signal converted into a signal in the time domain signal for each group while switching a group to be selected for each sample.

13. The receiver according to claim 8, wherein the at least one processor is configured to execute the instructions to:
convert the input signal from a serial signal to a block signal while providing a constant overlap between blocks,
divide the converted block signal into M signals, and
convert the sequentially selected signal from a block signal into a serial signal, while a domain not being affected by an assumption of periodicity included in the sequentially selected signal is left, and a domain that may be affected by an assumption of periodicity included in the sequentially selected signal is removed.

14. An equalization signal processing method comprising:
dividing, into M signals, an input signal of oversampling of a rational number M/L multiple in which M and L are natural numbers satisfying 1<M/L<2;
converting each of the divided M signals into a signal in a frequency domain;
performing an arithmetic operation of a first filter coefficient on M signals converted into a signal in the frequency domain:
performing an arithmetic operation of a second filter coefficient on, for each L group, M signals on which the arithmetic operation of the first filter coefficient is performed;
adding, for each group, M signals on which the arithmetic operation of the second filter coefficient is performed;
converting, for each group, the added output signal into a signal in a time domain;
sequentially selecting, for each group, a signal converted into a signal in the time domain, and concatenating a signal of each group; and
calculating a gradient of a loss function for the first filter coefficient and a gradient of the loss function for the second filter coefficient by using an error back propagation method, by using, as the loss function, a magnitude of a difference between the concatenated signal and a predetermined value, and updating the first filter coefficient and the second filter coefficient.
